(19) United States
(12) Patent Application Publication
(10) Pub. No.: US 2007/0277643 A1
(43) Pub. Date: Dec. 6, 2007

(54) Flex Plate with Attached Rim

(76) Inventors: Anthony W. King, Hudson, IN (US); Brett Peters, Auburn, IN (US); Jason Halprin, Angola, IN (US)

Correspondence Address: MAGNA INTERNATIONAL, INC., 337 MAGNA DRIVE, AURORA, ON, L4G-7K1, US

(21) Appl. No.: 11/756,090

(22) Filed: May 31, 2007

Related U.S. Application Data
(60) Provisional application No. 60/811,217, filed on Jun. 6, 2006.

(51) Int. Cl. F16C 15/00

(52) U.S. Cl. 74/572.2

(57) ABSTRACT

A flywheel for use with an automotive engine includes a central plate having an annular periphery surrounded by a ring gear. The ring gear includes an outer circumference having a plurality of radially-outwardly extending gear teeth and an inner circumferential surface. The ring gear is disposed about the annular periphery of the central plate. An adhesive is disposed between the inner circumferential surface of the ring gear and the annular periphery of the central plate fixedly securing the ring gear continuously about 360 degrees to the central plate.

### FIELD OF THE INVENTION

The invention relates primarily to flywheels, and more particularly to a two-piece flywheel and method of manufacturing a two-piece flywheel for use with an automotive engine.

### DESCRIPTION OF RELATED ART

A flywheel, or flexplate, is a well known component in an automotive vehicle. As appreciated, the flywheel operates as a mechanical coupling between an output of an engine and a torque converter, which is an input of a transmission. Specifically, one side of the flywheel is mounted to an engine crankshaft and another side is mounted to the torque converter. Rotation of the crankshaft causes the flywheel to rotate which thus causes the torque converter to rotate, all in unison since directly connected. Consequently, the flywheel transmits engine torque to the torque converter which connects, multiplies and interrupts the flow of engine torque to the transmission.

Additionally, the flywheel serves as an engagement point for a pinion gear of an electric starter motor. When the electric starter motor receives an electric current from a storage battery, the pinion gear is automatically brought into engagement with the flywheel and rotated, thereby causing the flywheel and hence crankshaft to rotate. Once the engine has started, that is, once the engine commences operation via the typical internal combustion cycle, the pinion gear is automatically disengaged, and the flywheel continues to rotate due to the movement of the crankshaft.

Referring to the prior art, a conventional two-piece flywheel 100 is detailed in FIGS. 1 and 2. The flywheel 100 includes a central plate, generally indicated at 102, of rotatably stiff but axially flexible relatively thin sheet metal. The central plate 102 is of generally constant axial thickness although variable thickness metal could be used if desired. The central plate 102 has a generally flat outer portion 104 and a slightly dished central portion 106. The central portion 106 includes a central opening 108 surrounded by a plurality of smaller openings 110 for aligning and mounting the flywheel 100 to the crankshaft 112. The degree of dishing is optional and depends primarily upon the space available between the crankshaft 112 and the torque converter 114. A plurality of annularly spaced apertures 116 extend through the outer portion 104 for mounting the flywheel 100 to the torque converter 114.

Beyond the outer portion 104, the central plate 102 includes an annular periphery 118. The annular periphery 118 defines a flange 120 extending away from the central plate 102 at approximately 90 degrees. A ring gear, generally indicated at 122, is sized to surround the annular periphery 118 and includes a plurality of radially-outwardly extending gear teeth 124 adapted to engage mating teeth on the pinion gear 126 of the electric starter motor. The ring gear 122 is intermittently fillet welded at 128 to a distal end of the flange 120 using a MIG welding process. It is also known in the art to intermittently fillet weld the ring gear 122 to the annular periphery 118 of the flange 120. Further, some prior art arrangements omit the flange 120 and intermittently fillet weld the ring gear 122 directly to the annular periphery 118.

Inherent in the design and construction of this two-piece flywheel 100 are such problems as: (1) lack of concentricity and gear teeth run-out, in which the ring gear 122 is not perfectly matched to the annular periphery 118 of the central plate 102 and in which case the gear teeth 124 therefore vary in radial distance from the crankshaft 112; (2) warping of the ring gear 122 and/or central plate 102 due to heat affected zones from the fillet welds 128, thus causing tolerances to be affected; and (3) weld spatter on the gear teeth 124 and the crankshaft and torque converter mounting surfaces due to the MIG welding process, thus requiring additional inspection and removal steps.

A second conventional flywheel is disclosed in U.S. Pat. No. 4,462,269 (the '269 patent) to Inglis. The '269 patent discloses a one-piece flywheel including a generally flat, central plate having a central opening surrounded by a plurality of smaller openings for aligning and mounting the flywheel to the crankshaft, and a ring gear integrally formed with and positioned around the central plate. The ring gear includes radially-outwardly extending gear teeth adapted to engage mating teeth on the pinion gear. A separate and distinct reinforcement segment or member is supplied in overlapping relationship with the gear teeth of the ring gear to provide additional strength to the gear teeth where the pinion gear is initially engaged.

Although this one-piece flywheel reduces concentricity and gear teeth run-out issues, as well as eliminates the welding issues, the one-piece design has its own inherent problems when compared to the two-piece flywheel 100. Specifically, the two-piece flywheel 100 is well known and widely used because the central plate 102 and ring gear 122 are manufactured of different materials selected to provide specific characteristics during operation of the flywheel 100. A typical central plate 102 would be made from material complying with S.A.E. J1392. In contrast, the ring gear 122 would typically be made from material such as S.A.E. 1038 to 1055 steel with carbon, heat-treated to a Rockwell “C” hardness of between 40 and 80. Using the different materials allows the central plate 102 to flex to a limited extent to help absorb and transmit forces exerted upon it during engagement with the pinion gear 126, while the ring gear 122 is designed to resist repeated impacts by the mating teeth of the pinion gear 126. Consequently, it is desirable to provide a two-piece flywheel and a method for manufacturing the two-piece flywheel that includes a ring gear fixedly secured continuously about 360 degrees to a central plate using an adhesive thereby eliminating welding issues while maintaining the advantage of using different materials for the central plate and ring gear.

### SUMMARY OF THE INVENTION

According to one aspect of the invention, a flywheel for use with an automotive engine includes a central plate having an annular periphery surrounded by a ring gear. The ring gear includes an outer circumference having a plurality of radially-outwardly extending gear teeth and an inner circumferential surface. The ring gear is disposed about the annular periphery of the central plate. An adhesive is disposed between the inner circumferential surface of the ring gear and the annular periphery of the central plate fixedly securing the ring gear continuously about the central plate.

According to another aspect of the invention, there is disclosed a method of manufacturing a flywheel. The flywheel includes a central plate having an annular periphery surrounded by a ring gear having an outer circumference with a plurality of radially-outwardly extending gear teeth and an inner circumferential surface fixedly secured to the annular periphery by an adhesive. The method includes the following steps. First, the inner circumferential surface of the ring gear is press-fit about the annular periphery of the central plate. Next, the adhesive is disposed between the inner circumferential surface of the ring gear and the annular periphery of the central plate to fixedly secure the ring gear continuously about the annular periphery of the central plate.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a plan view illustrating a conventional two-piece flywheel;

FIG. 2 is a cross-sectional view illustrating the conventional two-piece flywheel of FIG. 1 disposed between an engine crankshaft and torque converter;

FIG. 3 is a plan view illustrating a two-piece flywheel according to the invention;

FIG. 4 is a cross-sectional view illustrating the two-piece flywheel of FIG. 3 disposed between the engine crankshaft and torque converter;

FIG. 5 is a perspective view illustrating a ring gear of a second embodiment of the two-piece flywheel;

FIG. 6 is a perspective view illustrating a flexplate of the second embodiment of the two-piece flywheel;

FIG. 7 is fragmentary, enlarged cross-sectional view illustrating an assembled ring gear and flexplate of the second embodiment of the two-piece flywheel; and

FIG. 8 is a cross-sectional view illustrating a third embodiment of the two-piece flywheel.

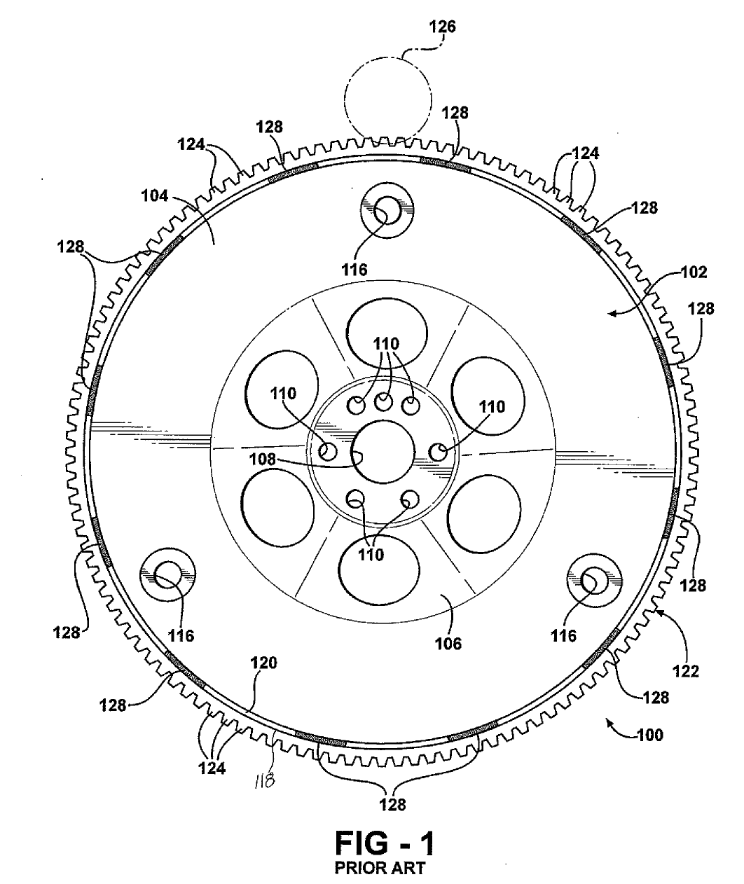

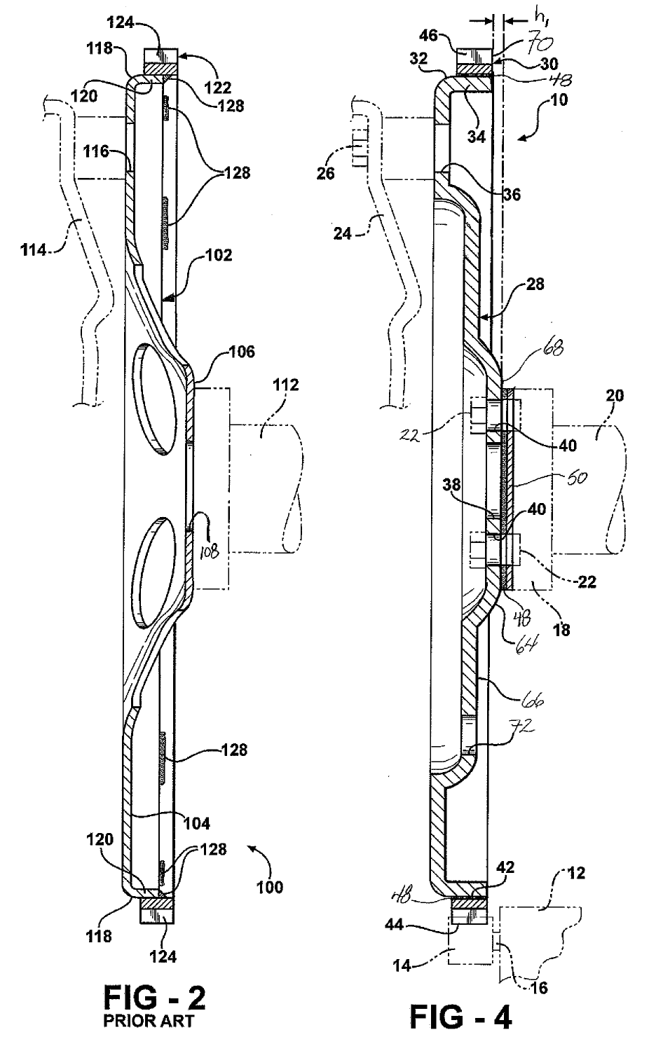

### DETAILED DESCRIPTION OF THE PREFERRED EMBODIMENTS

Referring to the Figures, wherein like numerals indicate like or corresponding parts throughout the several views, a two-piece flywheel or flexplate, manufactured according to the subject invention is generally shown at 10. Referring initially to FIG. 4, the flywheel 10 manufactured according to the subject invention is disposed between and provided for connecting an internal combustion engine (not shown in the Figures) and a transmission (not shown in the Figures) in an automotive vehicle (not shown in the Figures). An electric starter motor 12 includes a pinion gear 14 located on a drive shaft 16 rotatably coupled to the electric starter motor 12. As explained earlier, the pinion gear 14 of the starter motor 12 is brought into engagement with the flywheel 10 and rotated to start the engine. The pinion gear 14 is normally only in engagement with the flywheel 10 when the engine is being started, and is automatically withdrawn from engagement once the engine is started.

More specifically, the flywheel 10 is mounted to a hub 18 of an engine crankshaft 20 via mounting bolts 22. The flywheel 10 is also mounted to a torque converter 24, which is an input of the transmission, via mounting bolts 26. Rotation of the crankshaft 20 causes the flywheel 10 to rotate which thus causes the torque converter 24 to rotate, all in unison since directly connected. Consequently, the flywheel 10 transmits engine torque to the torque converter 24 which connects, multiplies and interrupts the flow of engine torque to the automatic transmission.

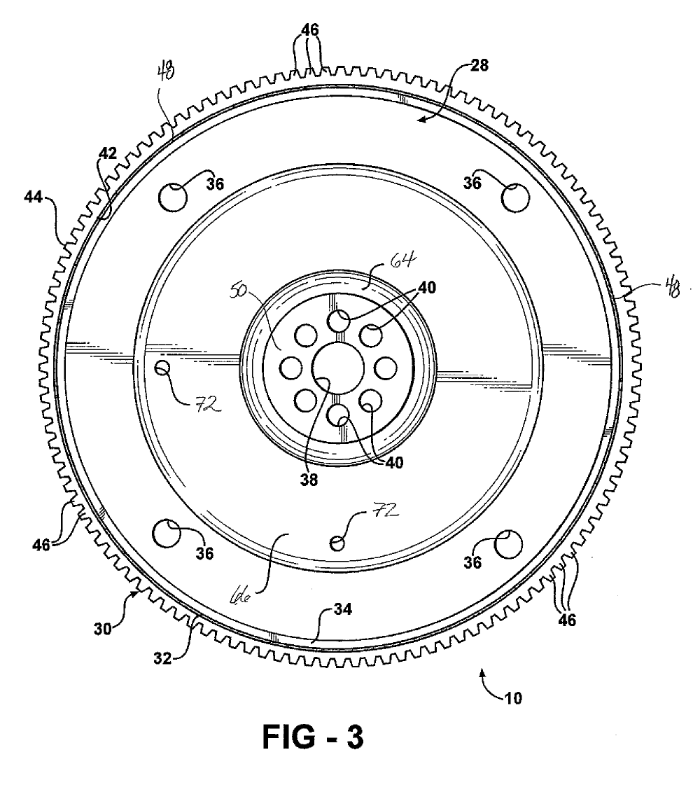

Referring now to FIGS. 3 and 4, the flywheel 10 includes a central plate, generally indicated at 28, surrounded by a ring gear, generally indicated at 30, fixedly secured thereto. The central plate 28 is a generally flat unitary stamping having an annular periphery 32 defined by an axially extending flange 34. As appreciated, the central plate 28 of the flywheel 10 is rotatably stiff but axially flexible such that it will flex to a limited extent to help absorb and transmit forces exerted upon it during engagement with the pinion gear 14 of the electric starter motor 12. The central plate 28 includes a plurality of apertures 36 for receiving the mounting bolts 26, or other fasteners necessary to properly secure the flywheel 10 to the torque converter 24. The central plate 28 terminates at a central opening 38 for aligning and mounting the flywheel 10 to the crankshaft 20. The central opening 38 is surrounded by a plurality of circumferentially spaced smaller openings 40 for receiving the mounting bolts 22, or other fasteners necessary to properly secure the flywheel 10 to the hub 18 of the crankshaft 20.

The ring gear 30 of the flywheel 10 includes an inner circumferential surface 42 and an outer circumference 44. The outer circumference 44 includes a plurality of radially-outwardly extending gear teeth 46. The inner circumferential surface 42 of the ring gear 30 is disposed about the annular periphery 32 of the central plate 28 and sized such that it is in press-fit engagement with the flange 34. Additionally, an adhesive 48 is disposed between the inner circumferential surface 42 and the annular periphery 32 fixedly securing the ring gear 30 continuously about 360 degrees to the central plate 28. The adhesive 48 is preferably ND 548 Retaining Compound. The plurality of gear teeth 46 are of a pitch and depth so as to engage with a plurality of mating teeth (not shown in the Figures) on the pinion gear 14 of the electric starter motor 12. The plurality of gear teeth 46 will vary with the type of engine, size of the flywheel 10, and type of pinion gear 14 used with the electric starter motor 12.

A separate reinforcing plate 50, best seen in FIG. 4, may be disposed between the hub 18 of the crankshaft 20 and the central plate 28 to disperse forces resulting from the crankshaft 20 and mounting bolts 22 as is commonly known to one skilled in the art. The reinforcing plate 50 is normally fixedly secured to the central plate 28 such as by spot welding, however, it will be appreciated that in the preferred embodiment the adhesive 48 is used. The reinforcing plate 50 includes a series of apertures of corresponding shape and size aligned with the central opening 38 and plurality of smaller openings 40 of the central plate 28.

The subject invention further includes a method for manufacturing the flywheel 10 including the central plate 28 having the annular periphery 32 defined by the flange 34 surrounded by the ring gear 30 having the inner circumferential surface 42 and the outer circumference 44 with the plurality of radially-outwardly extending gear teeth 46. The method includes an initial step of providing the central plate 28 pre-manufactured to include the annular periphery 32 defined by the flange 34, the plurality of apertures 36, the central opening 38, and the plurality of smaller openings 40, as described above. The central plate 28 may be formed to include a center stepped portion 64 and an outer stepped portion 66, as shown in FIG. 4. The central plate 28 is preferably made from material complying with S.A.E. J1392.

The method continues to include the step of providing the ring gear 30 pre-manufactured to include the inner circumferential surface 42 and the outer circumference 44 having the plurality of radially-outwardly extending gear teeth 46. The ring gear 30 is preferably made from material such as S.A.E. 1038 to 1055 steel with carbon, heat-treated to a Rockwell “C” hardness of between 40 and 80.

The method further includes the step of press-fitting the ring gear 30 to the central plate 28 such that the inner circumferential surface 42 is disposed about the flange 34 at the annular periphery 32. Also during the press-fitting operation, the ring gear 30 is located relative to a crank datum surface 68 to establish a gear face height h₁ measured from the crank datum surface 68 to a ring gear face 70, also shown in FIG. 4.

Prior to the step of press-fitting the ring gear 30 to the central plate 28, the method includes the step of applying the adhesive 48 to the inner circumferential surface 42 of the ring gear 30 and/or the annular periphery 32 of the central plate 28. Alternatively, the adhesive 48 is applied after the step of press-fitting the ring gear 30 to the central plate 28 and the adhesive 48 wicks between the inner circumferential surface 42 and the annular periphery 32 fixedly securing the ring gear 30 continuously about 360 degrees to the central plate 28.

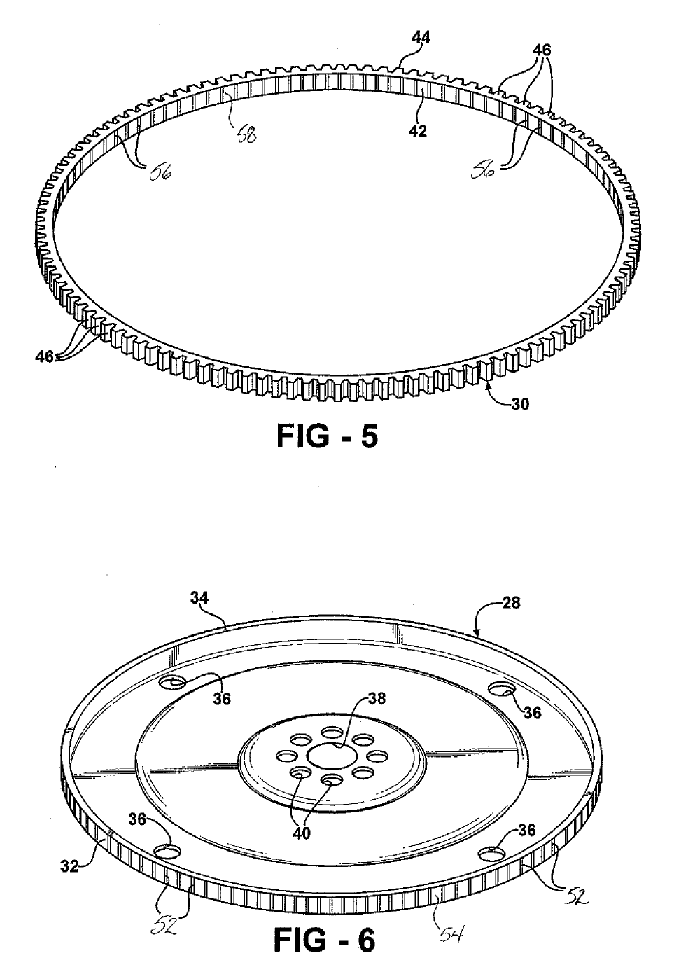

In a second embodiment shown in FIGS. 5 through 7, the flange 34 includes straight knurling 52 disposed around the annular periphery 32. The knurling 52 is preferably a series of small ridges protruding from a surface 54 of the annular periphery 32 of the flange 34. Similarly, straight knurling 56 protruding from a surface 58 of the inner circumferential surface 42 of the ring gear 30 is disposed therearound.

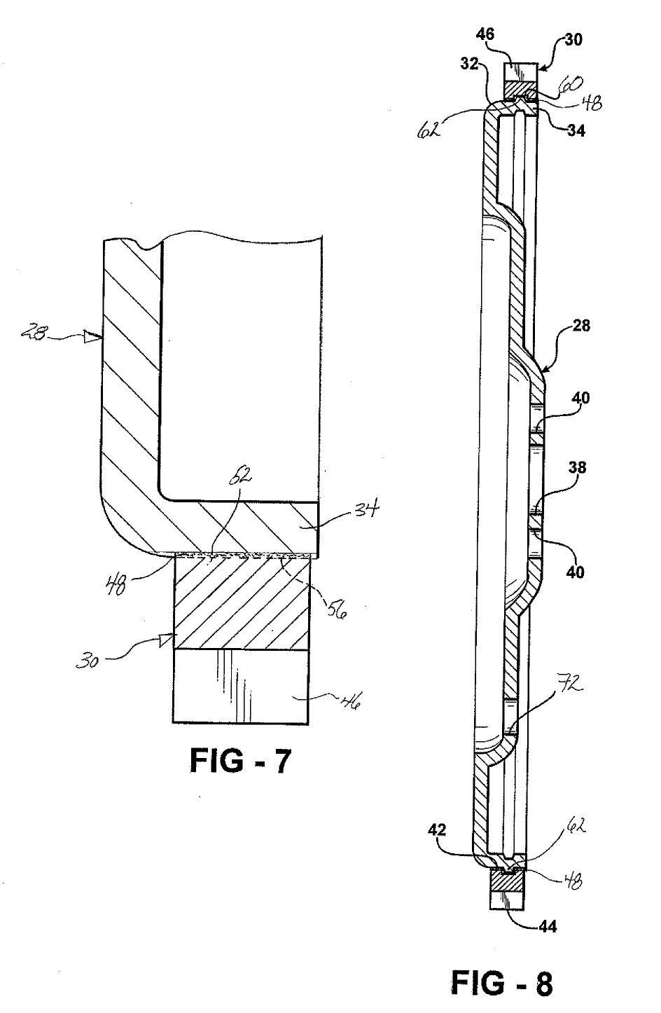

Referring to FIG. 7, when the ring gear 30 and central plate 28 are assembled, the inner circumferential surface 42 of the ring gear 30 is disposed about the annular periphery 32 of the central plate 28 and sized such that it is in press-fit engagement with the flange 34. The knurling 56 of the ring gear 30 is wedged between the knurling 52 of the central plate 28 lockingly coupling the ring gear 30 to the central plate 28 thereby preventing rotational slippage therebetween. Additionally, the adhesive 48 is disposed between the inner circumferential surface 42 and the annular periphery 32 fixedly securing the ring gear 30 continuously about 360 degrees to the central plate 28.

The subject invention also includes a method for manufacturing the second embodiment of the flywheel 10 including the central plate 28 having the annular periphery 32 defined by the flange 34 with straight knurling 52 disposed therearound surrounded by the ring gear 30 having the inner circumferential surface 42 with straight knurling 56 disposed therearound and the outer circumference 44 with the plurality of radially-outwardly extending gear teeth 46. The method includes the same steps as described above with respect to the preferred embodiment, however, the step of press-fitting the ring gear 30 to the central plate 28 further includes wedging of the knurling 56 of the ring gear 30 between the knurling 52 of the flange 34 to lockingly couple the ring gear 30 and central plate 28 together. It will be appreciated that when the adhesive 48 is applied after the step of press-fitting the ring gear 30 to the central plate 28, the knurling 56 of the ring gear 30 and knurling 52 of the flange 34 provide a path for helping the adhesive 48 wick between the inner circumferential surface 42 and the annular periphery 32 fixedly securing the ring gear 30 continuously about 360 degrees to the central plate 28.

Referring to FIG. 8, in a third embodiment, the inner circumferential surface 42 of the ring gear 30 includes a circumferential groove 60 extending therearound. The annular periphery 32 of the flange 34 includes a circumferential rib 62 extending therearound. The inner circumferential surface 42 of the ring gear 30 is disposed about the annular periphery 32 of the central plate 28 and sized such that it is in press-fit engagement with the flange 34. The rib 62 projecting from the annular periphery 32 of the flange 34 is disposed in the groove 60 lockingly coupling the ring gear 30 and the central plate 28. Additionally, the adhesive 48 is disposed between the inner circumferential surface 42 and the annular periphery 32 fixedly securing the ring gear 30 continuously about 360 degrees to the central plate 28.

A method for manufacturing the third embodiment of the two-piece flywheel 10 including the central plate 28 having the annular periphery 32 defined by the flange 34 with the circumferential rib 62 extending therearound surrounded by the ring gear 30 having the inner circumferential surface 42 with the circumferential groove 60 extending therearound and the outer circumference 44 with the plurality of radially-outwardly extending gear teeth 46 comprises the same steps as described above with respect to the preferred embodiment. The method for manufacturing the third embodiment, however, further includes the step of deforming a portion of the flange 34 to form the rib 62 extending into the groove 60 to lockingly couple the ring gear 30 and central plate 28 together.

Alternatively, the central plate 28 may be pre-manufactured to include the annular periphery 32 defined by the flange 34 with the circumferential rib 62 already extending therearound. In this case the method for manufacturing the third embodiment comprises the same steps as described above with respect to the preferred embodiment, and further includes the step of disposing the rib 62 into the groove 60 to lockingly couple the ring gear 30 and central plate 28 together.

The flywheel 10 of any of the three embodiments now includes the central plate 28 surrounded by the ring gear 30, as described above. The flywheel 10 manufactured according to the subject invention does not necessitate the incorporation of additional steps to visually inspect for and remove weld spatter contaminating the gear teeth 46 because the method does not include a welding step. Finally, the flywheel 10 is balanced by conventional methods of spin balancing with balance correction holes 72 being punched or drilled in the central plate 32 as needed and shown in FIGS. 4 and 8.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A flywheel for use with an automotive engine, said flywheel comprising:
a central plate including an outer annular periphery;
a ring gear including an outer circumference having a plurality of radially extending gear teeth and an inner circumferential surface, said ring gear disposed about said annular periphery of said central plate, and
adhesive disposed between said inner circumferential surface and said annular periphery fixedly securing said ring gear continuously about said central plate.

2. A flywheel as set forth in claim 1 wherein said adhesive is ND 548 retaining compound.

3. A flywheel as set forth in claim 2, further comprising a reinforcing plate fixedly secured to said central plate by said adhesive.

4. A flywheel as set forth in claim 1, wherein said annular periphery of said central plate is knurled.

5. A flywheel as set forth in claim 4, wherein said inner circumferential of said ring gear is knurled.

6. A flywheel as set forth in claim 5, wherein with said knurling of said ring gear is wedged between said knurling of said central plate.

7. A flywheel as set forth in claim 1, wherein said inner circumferential of said ring gear is knurled.

8. A flywheel as set forth in claim 1, wherein said inner circumferential has a circumferential groove extending therearound and a portion of said annular periphery is partially disposed in said groove lockingly coupling said ring gear and said central plate.

9. A flywheel a set forth in claim 1, wherein said annular periphery has a circumferential rib extending therearound; and said ring gear has a circumferential groove extending therearound, said rib engaging said groove lockingly coupling said ring gear and said central plate.

10. A method of manufacturing a flywheel comprising the steps of:
providing a central plate having an annular periphery;
providing a ring gear having an outer circumference with a plurality of radially extending gear teeth and an inner circumferential surface;
applying an adhesive on at least one of the inner circumferential surface of the ring gear and the annular periphery of the central plate;
press-fitting the ring gear about the annular periphery of the central plate, fixedly securing the ring gear about the annular periphery of the central plate.

11. A method of manufacturing a flywheel as set forth in claim 10, further comprising a step of knurling at least one the inner circumferential surface of the ring gear and the annular periphery of the central plate.

12. A method of manufacturing a flywheel as set forth in claim 10, wherein said providing steps including providing on one of said central plate and said ring gear a circumferential rib and providing on the other of said central plate and said ring gear a circumferential groove, and said step of press-fitting includes engaging the circumferential rib into the circumferential groove lockingly coupling the ring gear and central plate.

13. A method of manufacturing a flywheel as set forth in claim 10, further comprising a step of knurling the inner circumferential surface of the ring gear and knurling the annular periphery of the central plate.

14. A method of manufacturing a flywheel as set forth in claim 13, wherein the press fitting step includes wedging the knurling of the ring gear between the knurling of the annular periphery to lockingly couple the ring gear and central plate together.
